(19) United States
(12) Patent Application Publication
(10) Pub. No.: US 2009/0297250 A1
(43) Pub. Date: Dec. 3, 2009

(54) PEN CAP AND PEN BARREL COUPLING STRUCTURE

(75) Inventor: Jen-Hua HUANG, Chung Ho City (TW)

Correspondence Address: Ching-Ling Huang, 5597 NW 127th Ter, Portland, OR, 97229, US

(73) Assignee: BON ARTEK WRITING INDUSTRY CO., LTD., Chung Ho City, Taipei Hsien (TW)

(21) Appl. No.: 12/367,556

(22) Filed: Feb. 9, 2009

(30) Foreign Application Priority Data
May 28, 2008 (TW) 097209266

(51) Int. Cl. B43K 23/08

(52) U.S. Cl. 401/243

(57) ABSTRACT

A pen cap and a pen barrel coupling structure provides the pen cap formed in hollow to hold a magnet and an opening at one end and the pen barrel couplable with the opening of the pen cap and having a metal element attractable to the magnet. The pen cap and pen barrel have respectively a first coupling portion and a second coupling portion that correspond to and engageable with each other. The first and second coupling portions form a first coupling position to allow the magnet and metal element attracting to each other to form an anchor condition, and a second coupling position to separate the magnet and metal element to release the anchor condition. Thus by moving the pen cap against the pen barrel to the second coupling position, the pen cap can be separated from the pen barrel to make use of the pen easier.

### CROSS-REFERENCE TO RELATED APPLICATION

This application claims priority of Taiwanese application No. 097209266, filed on May 28, 2008.

### FIELD OF THE INVENTION

The present invention relates to a pen cap and a pen barrel coupling structure and particularly to a coupling structure to couple a pen cap and a pen barrel together through magnetic force.

### BACKGROUND OF THE INVENTION

A conventional writing instrument generally is coupled with a pen cap to guard the writing tip and users from impact that might cause deformation and ink interruption and also prevent the ink from smearing elsewhere, thus the pen cap is widely used on the market. In order to prevent the pen cap from separating from the pen barrel, the pen cap and the pen barrel have respectively a fastening means on the inner wall and outer wall thereof corresponding to each other. The most commonly adopted fastening means includes an anchor lug and an anchor notch that are latchable with each other to form an anchor condition. However, the anchor lug and the anchor notch tend to wear out or incur elastic fatigue after used for a prolonged period of time. As a result, friction deficiency occurs and the pen cap cannot be securely coupled on the pen barrel, and is easily loosened off and gets lost.

Many proposals have been submitted in prior art trying to resolve the aforesaid problem. For instance, R.O.C. patent No. M293849 discloses a pen with a movable pen cap. It has a barrel housing a core and a hollow pen cap with openings at two ends. The barrel and the pen cap have respectively a male screw thread and a female screw thread corresponding to each other for fastening. While it overcomes the conventional problems of wearing out and loosening off occurred to the pen cap, the pen cap and barrel have to be turned to form a full engagement or separation of the male screw thread and the female screw thread for stowing or using. It is tedious and inconvenient.

Another R.O.C. patent No. M316173 discloses a pen cap and barrel anchor structure. It mainly includes a hollow pen cap which has an opening side at one end and a magnet located inside. The opening side has an annular sealing portion. It also has a barrel to be coupled with the pen cap to form an anchor condition. The barrel has a metal element attractable to the magnet and a holding flute on a side wall thereof. The sealing portion mates the holding flute and can be held therein. The pen cap and the barrel can be coupled by the magnetic force of the magnet. The magnet provides a permanent magnetic force to allow the pen cap and the barrel to form a reliable coupling and prevent the pen cap from inadvertent loosening off. But it provides the coupling of the pen cap and the barrel through merely the magnetic force without other ancillary anchor structure. The magnetic force of the magnet has to be strong enough to provide the required coupling force between the pen cap and the barrel. As a result, a strong external force is needed to separate the pen cap and the barrel. Hence a greater effort is needed when in use.

### SUMMARY OF THE INVENTION

The primary object of the present invention is to solve the aforesaid disadvantages by providing a simpler and labor-saving structure to couple a pen cap and a pen barrel.

To achieve the foregoing object, the present invention provides a pen cap and a pen barrel coupling structure. The pen cap is hollow and has a magnet inside to provide a magnetic force and an opening at one end to couple with the pen barrel. The pen barrel has a metal element attractable to the magnet. The pen cap and the pen barrel have respectively a first coupling portion and a second coupling portion there correspond to and are couplable with each other. The first and second coupling portions also form a first coupling position and a second coupling position. At the first coupling position, the magnet and metal element are connected to form an anchor condition. At the second coupling position, the magnet and metal element are separated to release the anchor condition.

By means of the construction set forth above, the pen cap can be moved from the first coupling position to the second coupling position so that the magnet and the metal element are separated to free from magnetic attraction. Thus it is easier to separate and remove when in use.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the present invention in a stowing condition.

FIG. 2 is an exploded view of the present invention

FIGS. 3A and 3B are schematic views of the present invention in use conditions.

### DETAILED DESCRIPTION OF THE PREFERRED EMBODIMENT

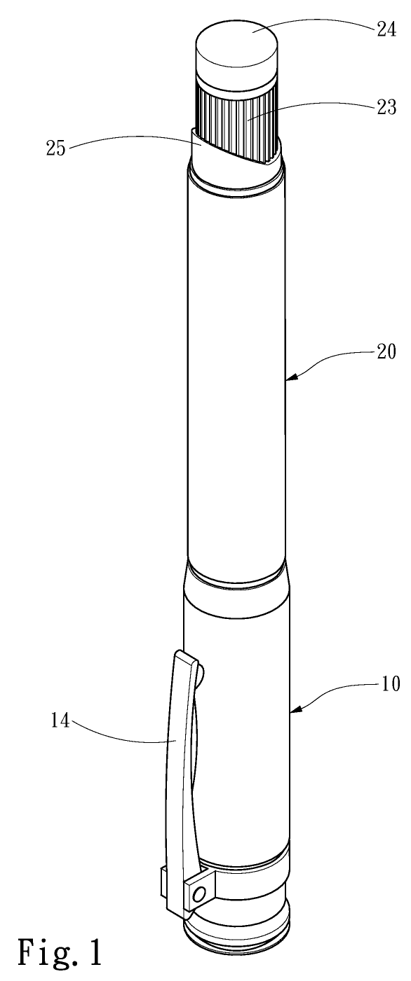

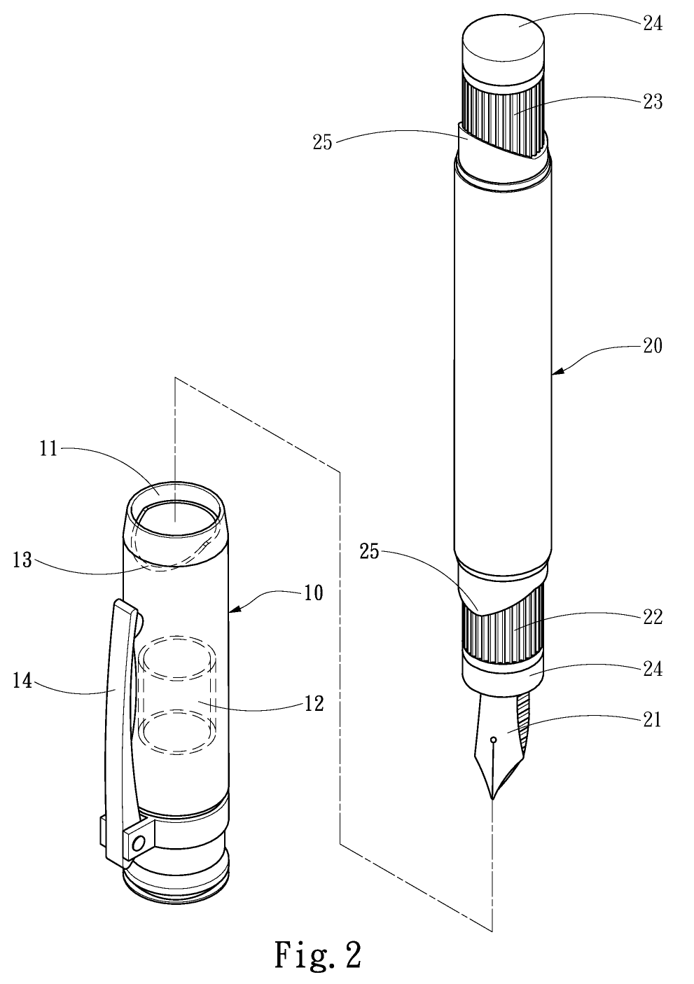

Please refer to FIGS. 1 and 2, the present invention mainly includes a pen cap 10 and a pen barrel 20. The pen cap 10 is hollow and has an inner wall holding a magnet 12 to provide a magnetic force. It also has an opening 11 at one end to couple with the pen barrel 20. The pen barrel 20 has a writing tip 21 and a front end 22 close to the writing tip 21 and a rear end 23 opposite to the writing tip 21. The front end 22 and the rear end 23 have respectively a metal element 24 attractable to the magnet 12 to form an anchor condition between them so that the pen cap 10 can be coupled on the front end 22 or rear end 23 of the pen barrel 20 to form a stowing condition or use condition. The pen cap 10 further has a first coupling portion 13. The pen barrel 20 has a second coupling portion 25 respectively at the front end 22 and the rear end 23 corresponding to and engageable with the first coupling portion 13. The drawings show an embodiment in which the first coupling portion 13 and the second coupling portion 25 are respectively an arched concave portion and a convex portion mating and couplable with each other. The concave and convex portions are not limited to the arched forms. They may also be inclined surfaces. The first and second coupling portions 13 and 25 also form a first coupling position to allow the magnet 12 to attract the metal element 24 to form the anchor condition, and a second coupling position where the magnet 12 and the metal element 24 are separated to release the anchor condition.

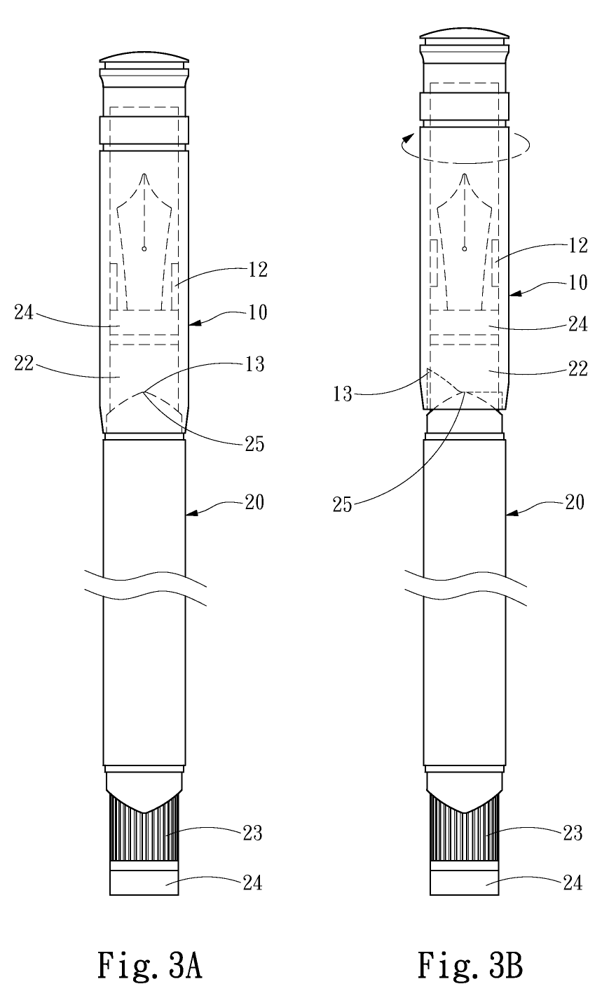

Refer to FIGS. 3A and 3B for the present invention in use conditions. Initially, the pen cap 10 is coupled on the front end 22 of the pen barrel 20 to form the stowing condition. The first and second coupling portions 13 and 25 are coupled at the first coupling position with the convex portion wedging in the concave portion, and the magnet 12 attracts the metal element 24 to form the anchor condition (as shown in FIG. 3A). Turn the pen cap 10 against the pen barrel 20, the concave portion separates from the convex portion. The first and second coupling portions 13 and 25 are at the second coupling position, and the magnet 12 and the metal element 24 also are separated, hence the magnetic force is no longer effective to the metal element 24, and the anchor condition is released (as shown in FIG. 3B). Thus the pen cap 10 can be removed from the pen barrel 20.

As a conclusion, the present invention provides the first coupling portion 13 of the pen cap 10 and the second coupling portion 25 of the pen barrel 20 that form the first coupling position in the anchor condition, and the second coupling position in the anchor-release condition. Thus by turning the pen cap 10 against the pen barrel 20 from the first coupling position to the second coupling position, the magnet 12 can be separated from the metal element 24 to release the magnetic force. As a result, separation of the pen cap and the pen barrel can be accomplished easily with less effort.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A pen cap and a pen barrel coupling structure having the pen cap formed in hollow and held a magnet and formed an opening at one end to couple with the pen barrel which has a metal element attractable to the magnet to form an anchor condition, comprising:
a first coupling portion of the pen cap and a second coupling portion of the pen barrel that correspond to and engageable with each other to form a first coupling position in the anchor condition and a second coupling position to release the anchor condition.

2. The pen cap and the pen barrel coupling structure of claim 1, wherein the first coupling portion and the second coupling portion are respectively a concave portion and a convex portion mating and engageable with each other.

3. The pen cap and the pen barrel coupling structure of claim 2, wherein the concave portion and the convex portion are arched surfaces.

4. The pen cap and the pen barrel coupling structure of claim 2, wherein the concave portion and the convex portion are inclined surfaces.

5. The pen cap and the pen barrel coupling structure of claim 1, wherein the second coupling portion is located at a front end close to a writing tip.

6. The pen cap and the pen barrel coupling structure of claim 1, wherein the second coupling portion is located at a rear end opposite to the writing tip.

7. The pen cap and the pen barrel coupling structure of claim 1, wherein the magnet is an annular element located on an inner wall of the pen cap.
